(19) United States
(12) Patent Application Publication
(10) Pub. No.: US 2007/0084947 A1
(43) Pub. Date: Apr. 19, 2007

(54) Irrigation sprinkler with integral flushing valve

(75) Inventor: Samuel C. Walker, Green Valley, AZ (US)

Correspondence Address: FITCH EVEN TABIN AND FLANNERY, 120 SOUTH LA SALLE STREET, SUITE 1600, CHICAGO, IL, 60603-3406, US

(73) Assignee: RAIN BIRD CORPORATION

(21) Appl. No.: 11/247,804

(22) Filed: Oct. 11, 2005

(51) Int. Cl. B05B 15/10

(52) U.S. Cl. 239/205; 239/204; 239/203

(57) ABSTRACT

A sprinkler is provided which enables flushing an irrigation system without the need to remove the nozzles. The sprinkler includes a stem with an integral flushing valve upstream of the nozzle and any filter for the nozzle. The flushing valve is operated to block flow through the flushing port for irrigating, block flow both through the stem and the flushing port so shut off the sprinkler, or block flow through the sprinkler stem while permitting flow through the flushing port, thereby allowing the irrigation system to be flushed of dirt and debris.

### FIELD OF THE INVENTION

The present invention relates generally to irrigation systems and, more particularly, to irrigation system sprinklers with an integral flushing valve.

### BACKGROUND OF THE INVENTION

Irrigation systems are used to provide water to a variety of devices for irrigating terrain and associated vegetation. Such irrigation systems traditionally have a network of conduit providing a source of water under pressure to a collection of distribution devices, such as sprinklers. A main control valve regulates the flow of water to the system. Sprinklers can be fitted with different forms of nozzles, such as a fixed spray nozzle, a variable arc spray nozzle, or a rotating stream sprinkler. The nozzles are often mounted on the top of a stem of the sprinkler.

A pop-up sprinkler is commonly used were the stem raises and lowers the nozzle between an elevated spraying position with the nozzle raised above a sprinkler housing when a main system water supply is turned on, and a retracted position wherein the stem is concealed substantially within the sprinkler housing when the main system water supply is turned off. A filter screen is usually provided at the nozzle or in the sprinkler stem to prevent dirt and debris from clogging the nozzle.

During the installation process, the passageways of an irrigation system, especially the conduit and the sprinklers, can become contaminated with dirt and debris. The network of conduit and the attached sprinklers should be flushed with a flow of water to remove the dirt and debris before attaching the filter screens and nozzles. However, in order to provide time and labor savings for installation, the nozzles are pre-installed on the stems. These leads to the possibility that contractors may, in practice, not temporarily remove the nozzles to properly flush the system after installation, thereby leading to the potential of clogged filter screens and inoperative nozzles.

Thus, it is desirable to provide the sprinklers with a mechanism that facilitates easy and fast flushing of the network of conduit and sprinklers without the necessity of removing the nozzles from each of the sprinklers.

### BRIEF DESCRIPTION OF THE DRAWINGS

FIG. 1 is a perspective view of a sprinkler including a flushing valve embodying features of the present invention;

FIG. 2 is a perspective view of the stem of the sprinkler of FIG. 1;

FIG. 3 is a partial elevational view of the stem of the sprinkler of FIG. 1;

FIG. 4 is a perspective view of a ball valve of the flushing valve of the sprinkler of FIG. 1;

FIG. 5 is another perspective view of the ball valve of FIG. 4;

FIG. 6 is another perspective view of the ball valve of FIG. 4;

FIG. 7 is a another perspective view of the ball valve of FIG. 4;

FIG. 8 is a perspective view of a valve seal of the flushing valve of the sprinkler of FIG. 1;

FIG. 9 is another perspective view of the valve seal sleeve of FIG. 6;

FIG. 10A is a perspective view of a seal pin of the flushing valve of the sprinkler of FIG. 1;

FIG. 10B is another perspective view of the seal pin of FIG. 10A;

FIG. 11 is a cutaway view of a portion of the stem of portion of FIG. 3 with the ball valve in the “on” position;

FIG. 12 is a cutaway view of a portion of the stem portion of FIG. 3 with the ball valve in the “off” position;

FIG. 13 is a cutaway view of a portion of the stem portion of FIG. 3 with the ball valve in the “flush” position;

FIG. 14 is a perspective view of an alternative embodiment of the ball valve of FIG. 4;

FIG. 15 is a perspective view of an alternative embodiment of the ball valve and valve seal of FIGS. 4 and 8; and

FIG. 16 is a perspective view of the valve seal of FIG. 15.

### DETAILED DESCRIPTION OF THE PREFERRED EMBODIMENT(S)

In FIG. 1, there is illustrated an irrigation sprinkler 2 that connects to an conduit delivering a source of water. The sprinkler includes a nozzle 4 to distribute the water for irrigation. The nozzle can take a variety of forms, including, for example, a fixed spray nozzle 4, a variable arc spray nozzle (not shown), or a rotating stream sprinkler (not shown). The sprinkler 2 includes a stem 6 and a housing 12 adapted to connect the sprinkler to the conduit. The sprinkler 2 is of a pop-up type sprinkler. The stem 6 is forced under pressure from the water to an extended position from the housing 12 for distributing water through the nozzle 4. The stem also retracts into the housing 12 via a spring (not shown) in the housing 12 when the water is shut off. The stem includes a distribution end 20 adapted, such as with threads 22, for mounting the nozzle 2. The housing 12 also includes a body 14, a cover 16, and an annular wiper seal 18 about the stem 6 extending through the cover 16.

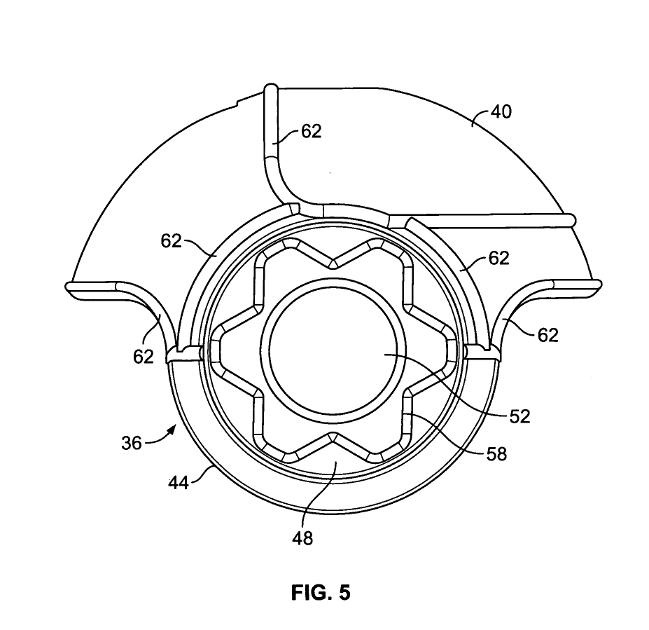

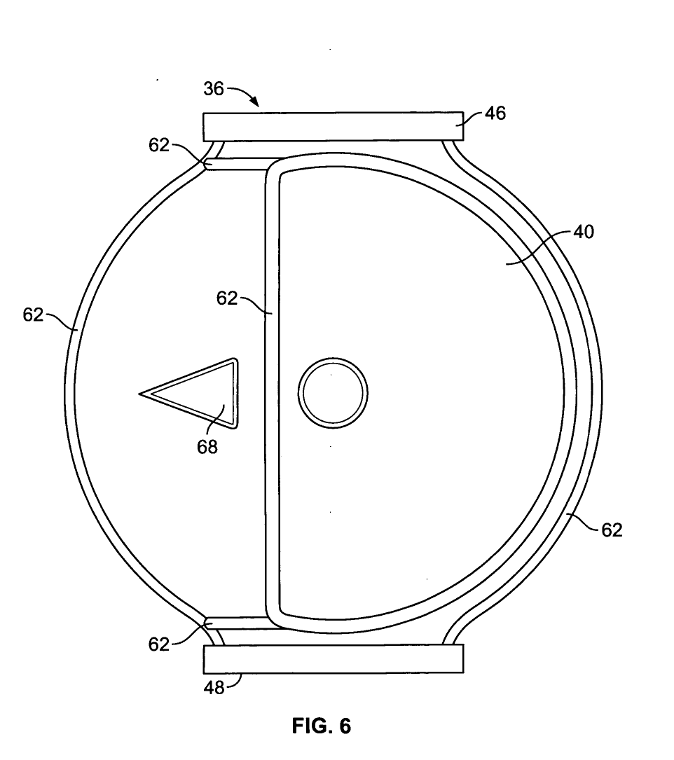

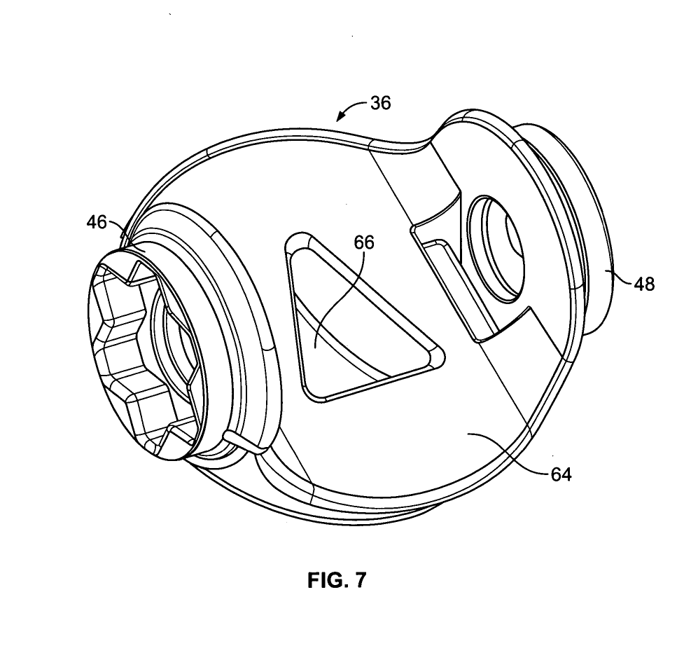

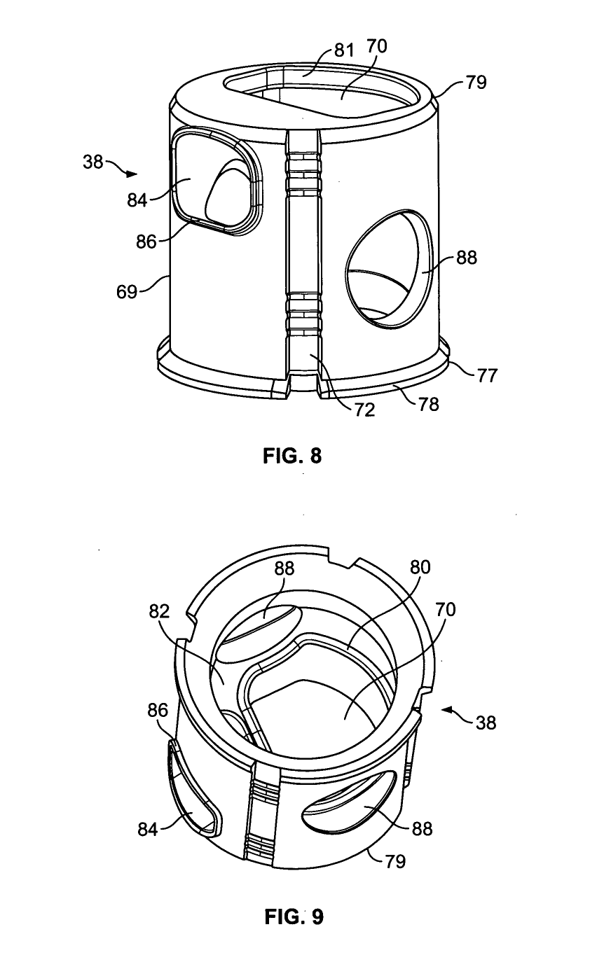

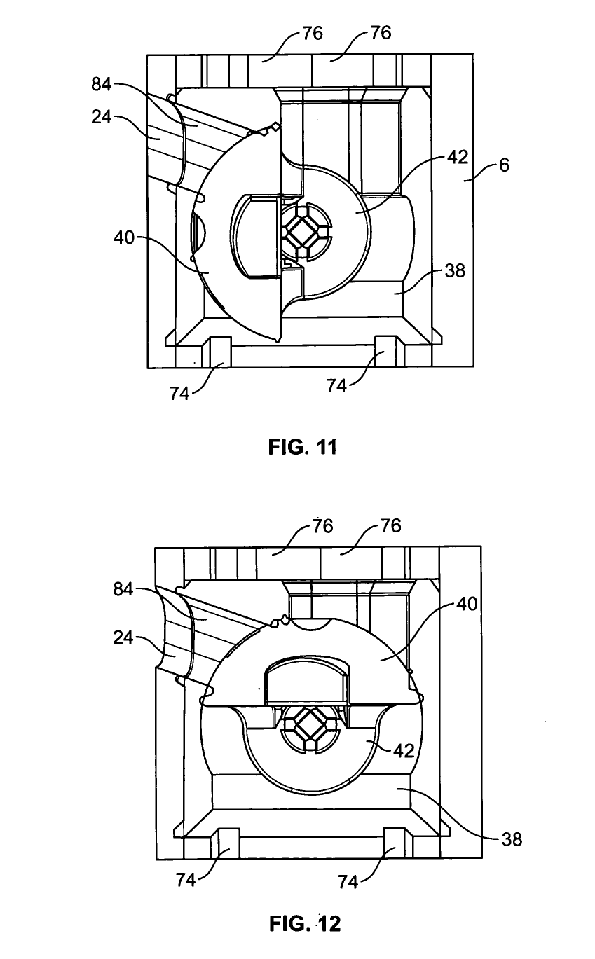

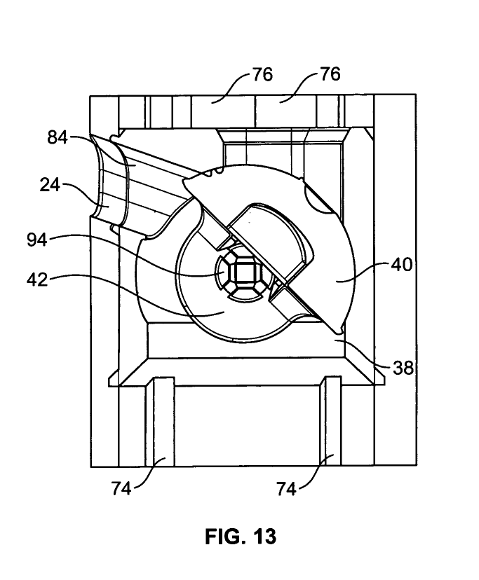

The stem 6 houses a flushing valve comprising a ball valve 36 (FIGS. 4-7) and a valve seal 38 (FIGS. 8 and 9). As illustrated in FIGS. 11-13, and discussed in further detail below, the ball valve 36 is rotatable between three positions: (1) a first position to allow water to flow to the nozzle 4 for irrigating (FIG. 11); (2) a second position to shut off flow of water to the nozzle 4 (FIG. 12); and (3) a third position to flush the sprinkler prior to the nozzle 4 (FIG. 13). The ball valve 36 is easily set to any one of the three positions and permits easy flushing of debris from the irrigation system through the sprinklers. The stem is generally cylindrical and has an outer wall 10. The outer wall defines a flushing aperture 24 which permits water to exit from the stem 6 prior to the nozzle 4 when the flushing valve is set to the third position (FIG. 13).

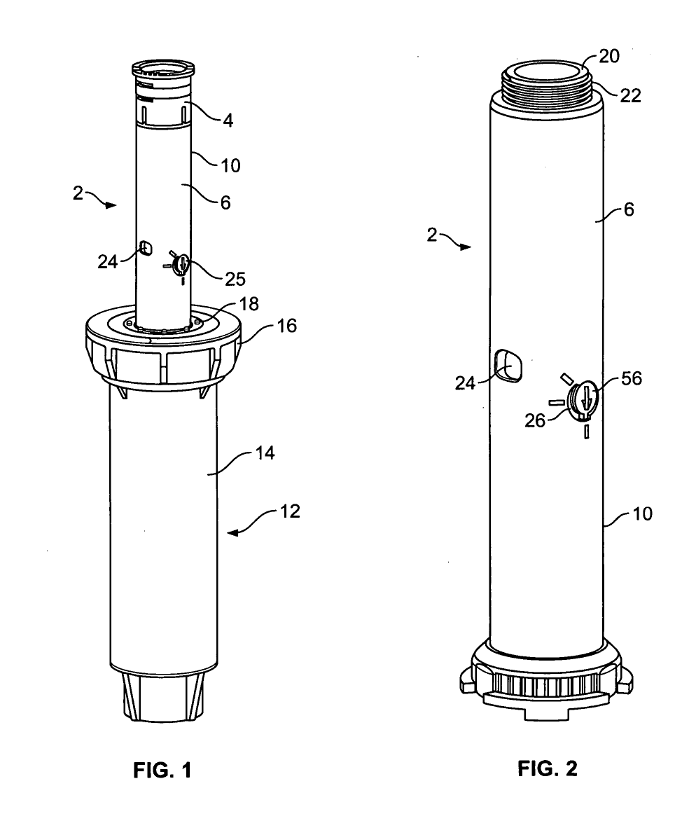

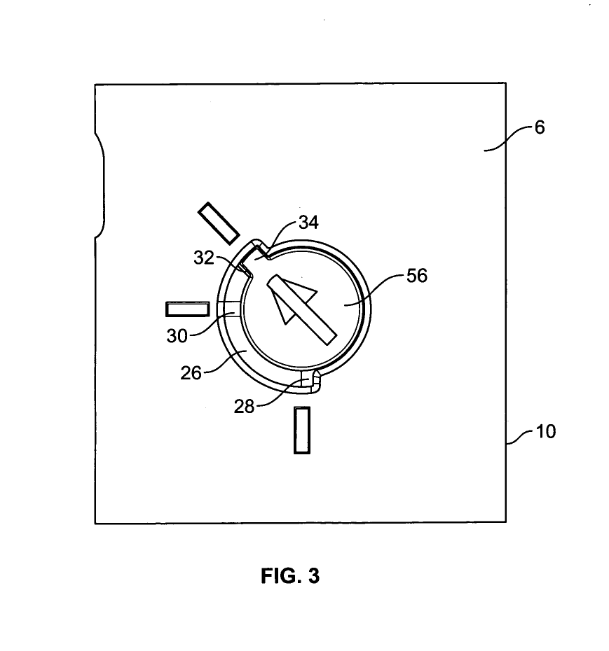

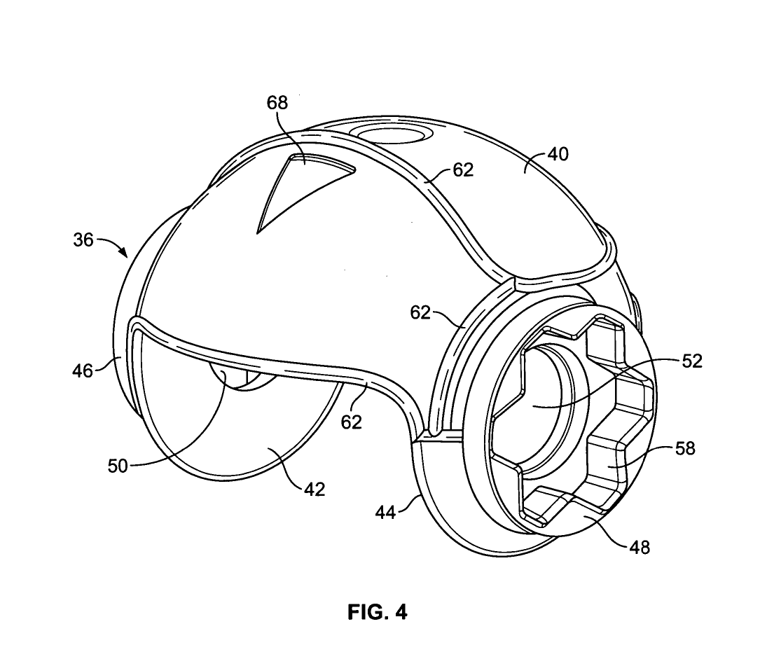

With reference to FIGS. 2 and 3, the outer wall 10 of the stem 6 defines two diametrically opposed seal pin openings 25 located on an axis that is roughly perpendicular to the flushing aperture 24. An arcuate depression 26 extends about one third of the circumference of each seal pin opening 25 and defines three detents or stops 28, 30 and 32 corresponding to the open, closed and flush positions of the sprinkler stem, respectively. The detent or stop 32 corresponding to the flush position is beneath a tab 34 (described below) in FIG. 3.

The flushing valve includes a ball valve 36 (FIGS. 4-7) and a valve seal 38 (FIGS. 8 and 9). As illustrated in FIGS. 11-13, the ball valve 36 is fitted into the valve seal 38, which, in turn, are mounted within the stem 6. As best illustrated in FIGS. 4-7, the ball valve 36 preferably takes the form of a spherical cap 40 having two diametrically opposed side flaps 42 and 44. Each side flap 42 and 44 has a raised disk 46 and 48, respectively. Each raised disk 46 and 48 defines a circular hole 50 and 52, respectively, configured to receive a connector portion 54 of a seal pin 56, as discussed below. Each raised disk 46 and 48 also defines a socket 58 above and about each of the holes 50 and 52 and configured to receive a complementary TORX-like driver 60 (FIG. 8A) of the seal pin 56, as discussed below.

The cap 40 has an outer surface 61 with raised sealing ridges 62 to facilitate a water tight seal between the ball valve 36 and the valve seal 38. Alternatively, sealing ridges could be configured on the valve seal 38 instead of on the ball valve 36. The flat, inner surface 64 of the spherical cap 40 defines a triangular relief 66 for engagement with a tool used during the assembly process, as described below. The outer surface 61 of the spherical cap 40 defines a triangular relief or pointer 68 that points in the direction of proper alignment for the cap 40 during the assembly process.

The valve seal 38 is preferably constructed of an elastomer material and has a shape of a generally cylindrical sleeve. The valve seal 38 is sized to be inserted with a friction fit into the stem 6 and defines a passageway 70 for the flow of water through the valve seal 38. The outer surface 69 of the valve seal 38 engages the innner surface of the stem 6. The outer surface 69 also defines four elongated grooves 72, which are spaced 90 degrees apart from each other, for receiving four complementary elongated lower ribs 74 (FIGS. 11-13)) in the stem 6. The lower ribs 74 extend longitudinally along the inside surface of the stem 6 from the flushing aperture 24 to the bottom 75 of the stem 6. The grooves 72 and lower ribs 74 cooperate to align the valve seal 38 within the stem 6. A group of upper ribs 76 (FIGS. 11-13) extend along the inside surface of the stem 6 downstream from the flushing aperture 24. The upper ribs 76 extend radially into the stem 6 a greater distance than the lower ribs 47 to provide a stop for the valve seal 38 to prevent it from being inserted too far into the stem 6 during the installation process or by water pressure during use.

The valve seal 38 includes an upstream end 77 and a downstream end 79. The upstream end 77 includes an annular flange 78 sloping inward in the direction of water flow. As water pressure in the stem increases, the sloped flange 38 is pressed outward with greater force against the inner surface of the stem 6. This facilitates an enhanced seal between the valve seal 38 and the stem 6. The inside of the valve seal 38 includes a ridge 80 about the passage 70 to facilitate an enhanced seal between the valve seal 38 and the ball valve 36.

The valve seal 38 has a spherically contoured wall 82 extending from about a midway point along the inner wall to the downstream end 79. The wall 82 is preferably formed by a gradual thickening of the wall of valve seal 38. At the downstream end 79 of the valve seal 38, the wall 82 obstructs slightly less than half of the passageway 70 to form an exit passage 81 from the passageway 70 at the downstream end 79. The thickened portion at the wall 82 of the valve seal 38 defines a side exit port 84 from the passageway 70. The exit port 84 has a generally rounded rectangular cross-section and angles downstream at approximately 60 degrees from the longitudinal axis of the valve seal 38. The exit port 84 is aligned with and sized to match the diameter of the flushing aperture 24 of the stem 6. A raised ridge 86 around the outside of the exit port 84 facilitates a seal with the stem 6.

The valve seal 38 defines two diametrically opposed seal pin holes 88. The seal pin holes 88 lie along an axis that is generally perpendicular to a longitudinal axis of the valve seal 38. Each seal pin 56 (FIGS. 11-13) extends through one of the seal pin openings 25 of the stem 6 and one of the seal pin holes 88 of the valve seal to attach to the ball valve 36. The seal pins 56 hold the ball valve 38 in place and drive the rotation of the ball valve 38 to the various operational positions.

With reference to FIGS. 8A and 8B, each of the seal pins 56 includes an inner disk 90 and an outer disk 101. The disks 90 and 101 form a groove 91 therebetween for holding an o-ring 92. The centrally positioned Torx-like driver 60 extends from an inside surface 93 of the inner disk 90. Each seal pin 57 also includes a connector portion 54 extending from the inside surface 94 of the Torx-like driver 60.

The connector portion 54 forms a hollow cylinder 96 sized to extend through the holes 50 and 52 of the ball valve 36 and has radially extending arcuate flange 98 for holding the connector portion 54 in the ball valve 36. The clydiner has a split wall 99 formed by four longitudinally extending notches 100. The notches create four arcuate wall segments 99a, 99b, 99c and 99d that can flex inward so that the flange 98 can pass through the holes 50 and 52 of the ball valve 36. Once through the holes 50 and 53, the flange 98 is biased outward by the wall segments 99a, 99b, 99c and 99d.

The outer disk 101 includes the radially extending tab 34 which provides a visual indication of the position of the ball valve 36. The tab 34 cooperates with the arcuate depression 26 of the stem 6 as described below. The outside of the outer disk defines a slot 102 for use with a tool, such as a screwdriver, to rotate the ball valve 36. The slot 102 is aligned with the tab 34 and has an arrowhead 104 along its end adjacent the tab 34 and pointing toward the tab 34.

To assemble and install the flushing valve, the ball valve 36 and the valve seal 38 are first assembled together by pressing the ball valve 36 into the valve seal 38. To do so, a holding pin configured to fit into the triangular relief 66 in the inner surface 64 the cap 40 of the ball valve 36 can be used. The valve seal 38 deforms slightly during insertion of the ball valve 36 to allow the side flaps 42 and 44 and the raised disks 46 and 48 of the ball valve 36 to pass through the passageway 70 until the raised disks 46 and 48 pop into the seal pin holes 88. The pointer 68 on the spherical cap 40 of the ball valve 36 should be pointed toward the exit or side port 84 to assist in aligning the ball valve 36 during insertion. Inserted in this manner, the ball valve 36 will initially be in the “off” position, as described below.

The ball valve 36 and the valve seal 38 subassembly is then inserted into the stem 6 with the grooves 72 of the valve seal 38 aligned to receive the lower ribs 74 of the stem 6 and with the exit port 84 of the valve seal 38 aligned with the flushing aperture 24 of the stem 6. The ball valve 36 and valve seal 38 subassembly is then pressed into the stem 6 until the valve seal 38 reaches the upper stop ribs 76. At this point, the exit port 84 and the flushing aperture 24 are aligned and the seal pin holes 88 in the valve seal 38 are aligned with the seal pin openings 25 of the stem 6.

The o-rings 92 are fitted into the annular grooves 91 on each of the seal pins 56. Then, the seal pins 56 are inserted into the seal pin openings 25 oriented with the arrowhead pointing toward to the horizontal detent or stop 30 (“off” position) in the arcuate depression 26. Each seal pin 56 is pressed in until the TORX-like driver 60 seats in the socket 58 of the disk 46 and 48 of the ball valve 36 and the connector portion 54 of the seal pin 56 locks into the holes 50 and 52 of the valve seal 36.

With the stem 6 so assembled, the ball valve 36 can be operated using a tool, such as a screwdriver, with one of the slots 102 of either of the seal pins 56 to rotate the ball valve 36 to one of the three desired positions where it will be held in place primarily by friction. In the first (“flow on”) position, as shown in FIG. 9, the ball valve 36 has been rotated so that it blocks flow through the flushing aperture 24, while permitting flow axially through the stem 6 to the nozzle 4 for irrigation. This represents the normal operating position of the ball valve 36 wherein the flow of irrigation water to the nozzle is determined by controlling the flow of water to the sprinkler 2. In the “flow on” position, the tab 34 of the seal pin 56 is located at the detent or stop 28 at the vertical position in the arcuate depression 26, providing a visual indicator of the position of the ball valve 36 to the user.

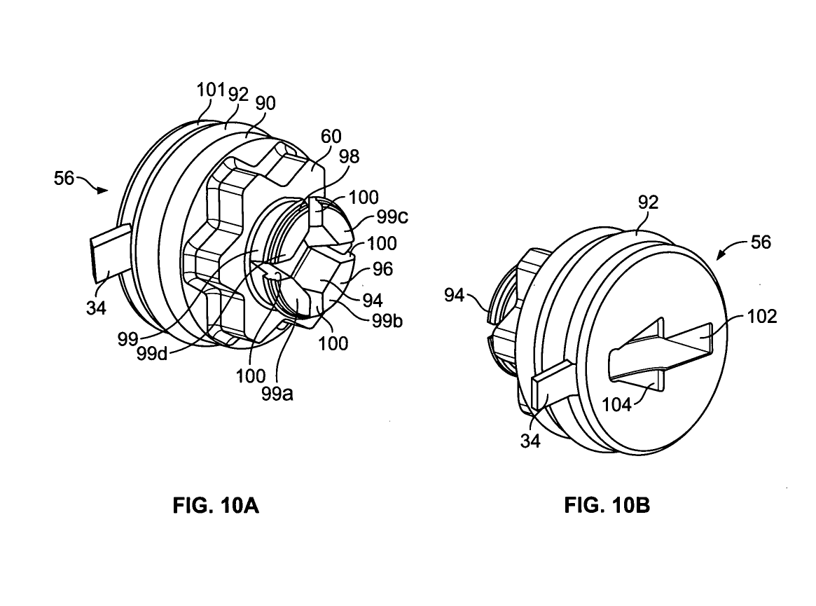

In the second (“flow off”) position, as shown in FIG. 10, the ball valve 36 has been rotated so that it blocks flow through the stem 6 at a position below the flushing aperture 24, thereby preventing flow through both the flushing aperture 24 and the stem 6. This position allows flow to an individual nozzle to be shut off, thus enabling the removal, replacement or change of the nozzle without necessitating the shutdown of the entire irrigation system. In this position, the tab 34 is located at the detent or stop 30 in the horizontal position of the arcuate depression 26.

Finally, in the third (“flush”) position, as shown in FIG. 11, the ball valve 36 has been rotated so that it blocks flow through the stem 6 at a point above the flushing aperture 24. This allows flow out from the stem 6 through the exit port 84 and the flushing aperture 24 while blocking flow to the nozzle 4 of the sprinkler 2. This position allows an installer or an operator to flush dirt and debris out of the irrigation system without needing to remove the nozzle. In this position, the tab 34 is located at the third detent or stop 32 in the arcuate depression 26.

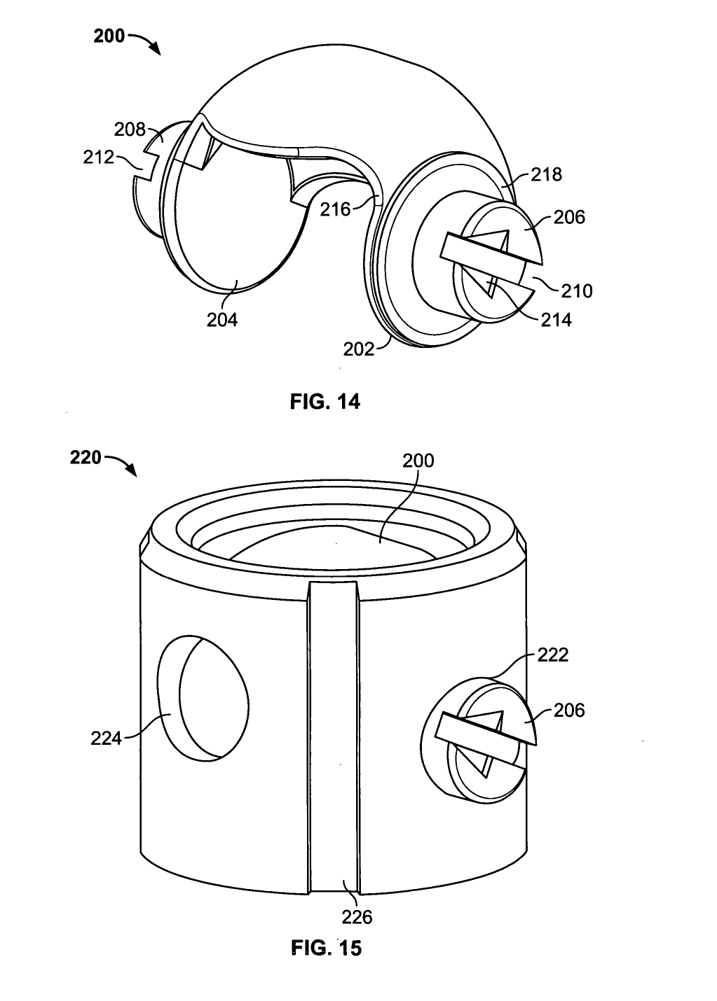

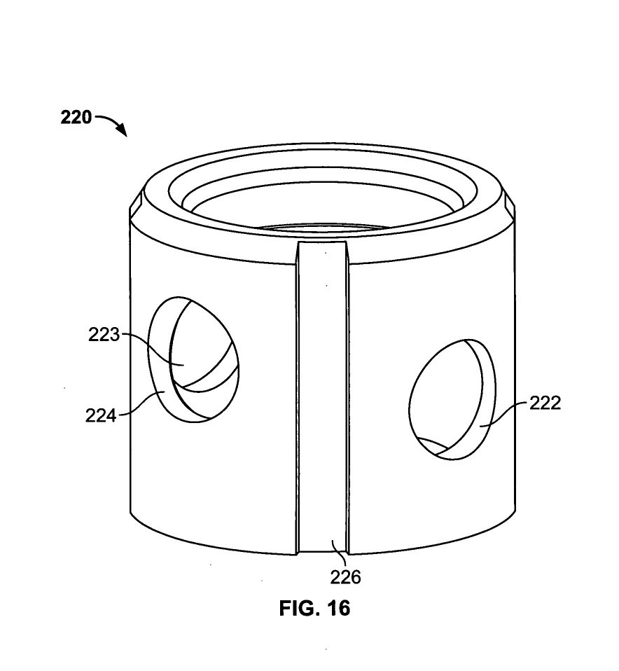

In an alternative embodiment, shown in FIGS. 14 and 15, the ball valve 200 may take the form of a partial sphere with two opposed side flaps 202 and 204. Trunnions 206 and 208 extend from one or both of the side flaps 202 and 204 respectively. Each trunnion 206 and 208 defines a slot 210 and 212 respectively at its terminal end. At least one of the slots 210 and 212 defines an arrowhead 214 at one end of the slot to indicate the position of the ball valve 200. Raised sealing ridges 216 on the surface of the ball valve 200 and a raised sealing ridge 218 around each trunnion 206 and 208 facilitate a water tight seal between the ball valve 200 and a valve seal 220 (FIG. 15) configured to cooperate with the ball valve 200.

The valve seal 220 of the alternative embodiment, as seen in FIG. 15, is preferably constructed of an elastomer material and has the shape of a generally cylindrical sleeve. The outside diameter of the valve seal 220 is sized to be inserted with a friction fit into the stem 6. The valve seal defines a pair of diametrically opposed trunnion openings 222 and 223 and an exit port 224 intermediate of the trunnion openings 222 and 223. The trunnion openings 222 and 223 are sized to allow a trunnion 206 208 to pass through the valve seal and fit into openings 25 (FIG. 1) in the outer wall 10 of the stem 6. The exit port 224 is configured to align with the flushing aperture 24 (FIG. 1) in the outer wall 10 of the stem 6. The valve seal 220 defines four elongated grooves 226, spaced about 90 degrees apart around the outside surface of the valve seal 220, for receiving four complementary elongated lower ribs 74 (FIGS. 11-13), as with the previously described embodiment.

Using the irrigation sprinkler as described herein, an installer may realize great time and labor savings. Nozzles can be pre-mounted on the sprinkler and the valves set to the “flush” position. As the water supply network is laid into the ground, the sprinkler with the nozzles already attached can be joined to the network. After installing all of the sprinklers, the irrigation system can be activated, causing a flow of water to flush dirt and debris out the flushing apertures in the stems while protecting the nozzles and any associated screens or filters from getting clogged. The system can then be deactivated and the valves set to their “flow on” positions, readying the system for normal irrigating operation. More importantly, the valves can be moved to their “flow on” positions without deactivating the irrigation system, thereby achieving great savings in time and labor.

The valve also can be set to the “flow off” position to shut off a sprinkler to take it out of operation and facilitate maintenance, repair or replacement of the nozzle or the screen.

The foregoing relates to a preferred exemplary embodiment of the invention. It is understood that other embodiments and variants are possible which lie within the spirit and scope of the invention as set forth in the following claims.

1. An irrigation sprinkler comprising:
a stem having an inlet end adapted for connection to a supply of water and an outlet end adapted for connection to a water distribution head and defining a flushing port intermediate the inlet end and the outlet end; and
a valve rotatably mounted in the stem, the valve being rotatable between a first position permitting water flow through the stem from the inlet end to the distribution head end while preventing water flow through the flushing aperture, a second position at least substantially preventing water flow through the stem from the inlet end to the distribution head end and through the flushing aperture, and a third position at least substantially preventing water flow through the stem from the inlet end to the distribution head end while permitting water flow from the inlet end through the flushing aperture.

2. The irrigation sprinkler of claim 1 wherein the valve comprises a ball valve with at least a portion relieved.

3. The irrigation sprinkler of claim 2 further comprising at least one drive pin to drive the ball valve from outside the stem.

4. The irrigation sprinkler of claim 3 wherein the ball valve defines at least one socket and the at least one drive pin includes at least one driver that is received in the at least one socket to form a driving engagement.

5. The irrigation sprinkler of claim 3 wherein the stem defines at least one aperture spaced from the flushing port and the at least one drive pin being configured to pass through the at least one aperture to enable rotation of the ball valve from outside the stem.

6. The irrigation sprinkler of claim 5 wherein the at least one aperture comprises a first and second aperture spaced from the flushing port and the at least one drive pin comprises a first and second drive pin, the first and second drive pins each being configured to pass through one of the first and second apertures and to enable rotation of the ball valve.

7. The irrigation sprinkler of claim 3 wherein the at least one drive pin comprises an indicator of the position of the ball valve.

8. The irrigation sprinkler of claim 7 wherein the valve stem cooperates with the at least one drive pin to define at least the first, second and third positions for the ball valve.

9. The irrigation sprinkler of claim 2 further comprising a valve seal located at least partially between the ball valve and the stem, the valve seal defining an exit port aligned with the flushing port.

10. The irrigation sprinkler of claim 9 further comprises at least one drive pin to drive the ball valve from outside the stem.

11. The irrigation sprinkler of claim 10 wherein the ball valve defines at least one socket and the at least one drive pin includes at least one driver that is received in the at least one socket to form a driving engagement.

12. The irrigation sprinkler of claim 11 wherein the stem defines at least one aperture spaced from the flushing port, the seal defines at least one aperture spaced from the exit port and the at least one drive pin being configured to pass through the at least one aperture of the stem and the at least one aperture of the seal to enable rotation of the ball valve from outside the stem.

13. The irrigation sprinkler of claim 12 wherein the at least one aperture of the stem comprises a first and second aperture spaced from the flushing port, the at least one aperture of the seal comprises a third and fourth aperture spaced from the exit port, and the at least one drive pin comprises a first and second drive pin, the first drive pin being configured to pass through the first and third apertures of the stem and seal and the second drive pin being configured to pass through the second and fourth apertures of the stem and the seal.

14. The irrigation sprinkler of claim 9 wherein the stem comprises at least one internal stop to restrict movement of the ball valve and the seal in the stem.

15. The irrigation sprinkler of claim 9 further comprising a housing and the stem being supported by the housing to move between an extended position from the housing for irrigating and a retraced position at least substantially within the housing when not irrigating.

16. The irrigation sprinkler of claim 2 wherein the ball valve comprises at least one trunnion.

17. The irrigation sprinkler of claim 16 wherein the stem defines at least one aperture spaced from the flushing port and the at least one trunnion being configured to pass fit into the at least one aperture to enable rotation of the ball valve from outside the stem.

18. The irrigation sprinkler of claim 17 further comprising a valve seal located at least partially between the ball valve and the stem, the valve seal defining an exit port aligned with the flushing port.

19. The irrigation sprinkler of claim 18 wherein the seal defines at least one aperture spaced from the exit port and the at least one trunnion being configured to pass through the at least one aperture of the seal and the at least one aperture of the stem to enable rotation of the ball valve from outside the stem.

20. A method of flushing an irrigation system comprising:
providing at least one irrigation sprinkler comprising a stem having an inlet end adapted for connection to a supply of water and an outlet end adapted for connection to a water distribution head and defining a flushing port intermediate the inlet end and the outlet end, and a valve rotatably mounted in the stem, the valve being rotatable between a first position permitting water flow through the stem from the inlet end to the distribution head end while preventing water flow through the flushing aperture, a second position at least substantially preventing water flow through the stem from the inlet end to the distribution head end and through the flushing aperture; and a third position at least substantially preventing water flow through the stem from the inlet end to the distribution head end while permitting water flow from the inlet end through the flushing aperture;
rotating the valve to the third position;
causing water to flow through the irrigation system; and
rotating the valve to first position.
